(19) United States
(12) Patent Application Publication
(10) Pub. No.: US 2005/0289017 A1
(43) Pub. Date: Dec. 29, 2005

(54) Network transaction system and method

(76) Inventor: Efraim Gershom, Overland Park, KS (US)

Correspondence Address: CHASE LAW FIRM L.C, 4400 COLLEGE BOULEVARD, SUITE 130, OVERLAND PARK, KS, 66211, US

(21) Appl. No.: 11/131,813

(22) Filed: May 18, 2005

Related U.S. Application Data
(60) Provisional application No. 60/572,524, filed on May 19, 2004.
(60) Provisional application No. 60/623,917, filed on Nov. 1, 2004.

(51) Int. Cl. G06Q 30/00

(52) U.S. Cl. 705/27; 705/26

(57) ABSTRACT

A network transaction system is provided for peer-to-peer commerce in private and public marketplaces among system users. The users direct criteria for access to each other and third parties at desired levels of participation in vertical markets. Automatic reply functions are activated in response to queries according to user-defined criteria. The system accommodates transactions of various kinds over networks corresponding to the private and public marketplaces, which can interface with each other according to the user-defined criteria. Inventory and catalog database functions reside on the users' computers for management by the user or client system software.

### CROSS-REFERENCE TO RELATED APPLICATION

This application claims the benefit of U.S. provisional applications No. 60/572,524, filed May 19, 2004, and No. 60/623,917, filed Nov. 1, 2004. Both of these provisional patent applications are incorporated herein by reference.

### BACKGROUND OF THE INVENTION

1. Field of the Invention

The present invention relates generally to computer network transactions, and in particular to systems and methods for conducting commerce using peer-to-peer technology over a network, such as the Internet.

2. Description of Related Art

Computer networks have been applied to a wide variety of commercial transactions. For example, the Internet (worldwide web) is extensively used for electronic (“e”) commerce. Among its advantages are access to millions of subscribers worldwide, who represent potential vendors of goods and services and customers for same. However, there are a number of disadvantages associated with conducting business on the Internet. For example, contacts are often controlled by search engines, which rank and prioritize “hits” or “matches” according to predetermined criteria, which may be inconsistent with the objectives of the parties to the transactions. Moreover, merely by accessing the Internet, users' computers are exposed to unwanted communications (i.e. “spam”), spyware, viruses, cookies and possibly unauthorized access by others, all of which tend to reduce the effectiveness of the Internet for its intended uses, e.g. among users in vertical markets. Still further, Internet-based transactions tend to be somewhat slower and less secure than peer-to-peer transactions.

The Internet has also given rise to peer-to-peer communications. These peer-to-peer communications are for file sharing and instant messaging.

Typical file sharing programs are those provided by well known web sites, such as Napster™ (www.napster.com), and Kaza™ (www.kaza.com). In these file sharing programs, the home server has access to the complete inventory of files a user seeks to share with other users. In some cases, these inventories of users' files sought to be shared are available to be viewed by other users. As content regulation is uncontrolled, these file sharing programs are either public domain, or facilitate the distribution of illegal and/or unauthorized copies of files, such as movies, music, games, television programs, etc.

Instant messaging, such as MSN Messenger from Microsoft® and ICQ®, opens communication between two users who have identified themselves to each other through a common data object. As a result, instant messaging is limited to communication between previously known people.

These peer-to-peer communications do not store data about the communication between users. Moreover, these peer-to-peer communications do not organize any of the data sought to be shared and/or stored.

Some of the currently available peer-to-peer and other network transaction systems have the disadvantage of sharing too much data among users. For example, sellers of goods and services may prefer not to provide access to their entire inventories. Likewise, participants to information exchange transactions may prefer to control users' access to their data files. Sellers can often achieve greater efficiencies in their transactions by restricting the goods or services involved to specific catalogs and by providing information only to select groups of potential customers, or even individual customers in reply to specific queries.

Heretofore there has not been available a network transaction system and method with the advantages and features of the present invention.

### BRIEF DESCRIPTION OF THE INVENTION

The present invention improves on the contemporary art by providing systems and methods for use in a wide area network, such as the Internet, that allow sellers of goods and services to prevent access to their entire inventories. Likewise, participants to information exchange transactions may prefer to control users' access to their data files. Sellers can often achieve greater efficiencies in their transactions by restricting the goods or services involved to specific catalogs and by providing information only to select groups of potential customers, or even individual customers in reply to specific queries.

The present invention provides an alternative or supplemental desktop transaction application to transaction systems that utilize search engines, web-based locating services, conventional e-commerce services and the like. Preferably, such a system provides private marketplace applications (including without limitation peer-to-peer and other restricted access networks), with advantages of speed, efficiency, automation and data organization, and can be adapted for general purposes or vertical markets corresponding to particular industries. Private marketplace advantages include controlled access, which reduces spyware and other problems associated with unrestricted access, which tend to reduce the effectiveness of communications among users.

In the practice of one aspect of the present invention, a system is provided for connecting users, such as buyers and sellers, over a network, e.g. the Internet, a local area network (LAN), a wide area network (WAN), etc. The system can include a home server and multiple client or user servers. The system enables user-directed participation in transactions. For example, rules and filters can be established at the home server and client server levels for greater flexibility by users in directing their participation in the system and the public and private marketplaces accessed thereby. such rules and filters control the data objects pushed onto and downloaded from the network by users. For example, the data objects can correspond to queries and replies communicated among the users. The home server can route such queries and replies among the users according to its rules and filters at a high-level of screening. At the lower, user level, additional rules and filters are applied.

The system preferably utilizes the computing power of the users' or clients' computers, which contain their data and functionalities, such as inventories transaction criteria. By distributing the data and functions in this matter, home server involvement in transactions is limited, thereby reducing its complexity and potentially increasing the speed with which the home server routes to transaction communications.

The system further facilitates user-directed participation at different levels within vertical markets whereby users have control over who receives their queries and replies. For example, sellers can control the potential customers with access to their inventories or catalogs. Moreover, private marketplaces can be established for access only by selected users who choose to exclusively deal with each other according to certain common interests, rules, etc. Such markets can be either public or private, with optional links to out-of-network third parties, e.g. over the Internet. Other user-directed functionalities include logic for matching transactions with potential participants and automated reply functions, which are activated by such matches.

### BRIEF DESCRIPTION OF THE DRAWINGS

The drawings constitute a part of this specification and include exemplary embodiments of the present invention and illustrate various objects and features thereof.

FIG. 1 is a high level diagram of a network transaction system embodying the present invention.

FIG. 1A is a private marketplace diagram showing the communication of queries and replies among system users.

FIG. 1B is a diagram showing the relationships among public marketplaces, private marketplaces and private hotlines, which interact with the system.

FIG. 1C is a diagram particularly showing applications of the system reply functions.

FIG. 2 is a buyer-server-seller flow diagram thereof.

FIG. 3 is a flow diagram of an e-commerce transaction method embodying the present invention, showing the buyer side thereof.

FIG. 4 is a flow diagram showing the seller side thereof.

FIG. 5 is a diagram showing a data distribution/broadcast/hotline function thereof.

FIG. 6 is a diagram showing a data exchange function thereof.

FIG. 7 is a diagram showing an auction function thereof.

FIG. 8 is a diagram showing a seller-initiated classifieds function thereof.

FIGS. 9-26 are screen displays showing the operation of the system and method of the present invention.

### DETAILED DESCRIPTION OF THE INVENTION

Introduction

As required, detailed embodiments and/or aspects of the present invention are disclosed herein; however, it is to be understood that the disclosed embodiments/aspects are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriate system or method.

Network Transaction System and Method Description

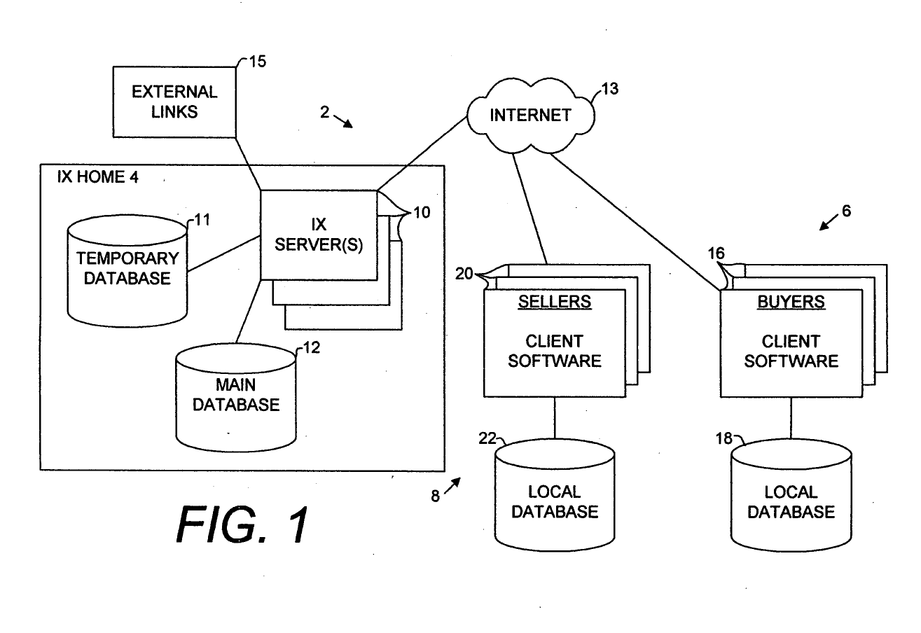

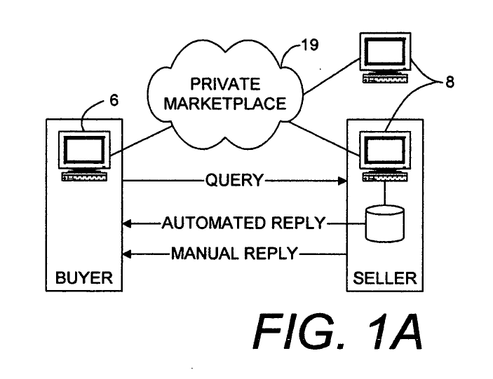

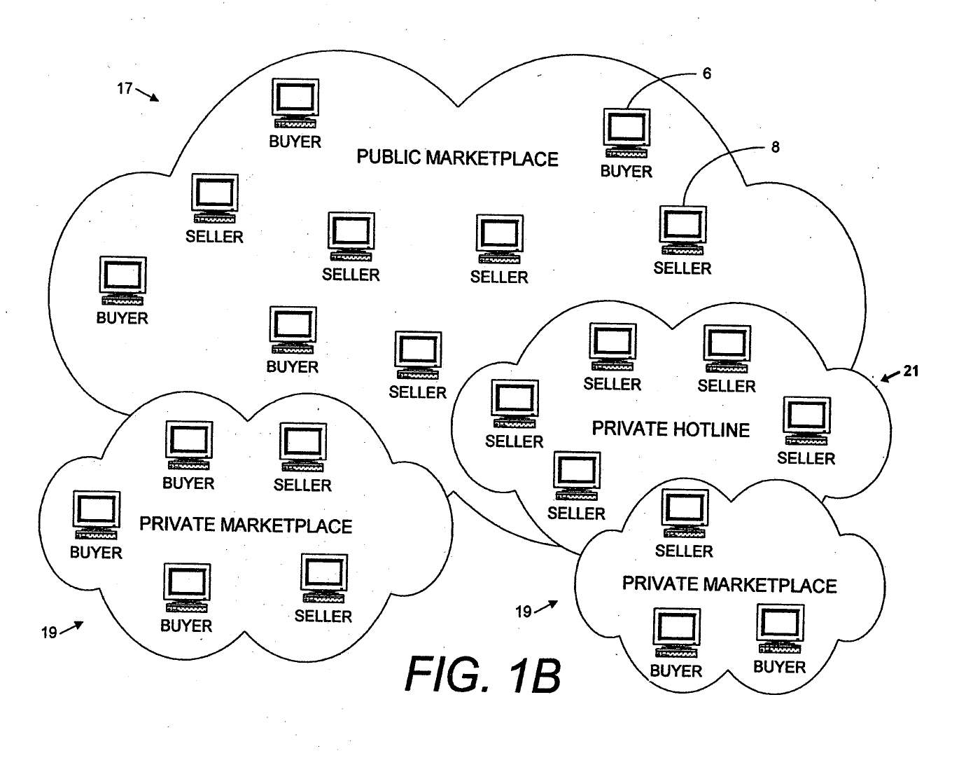

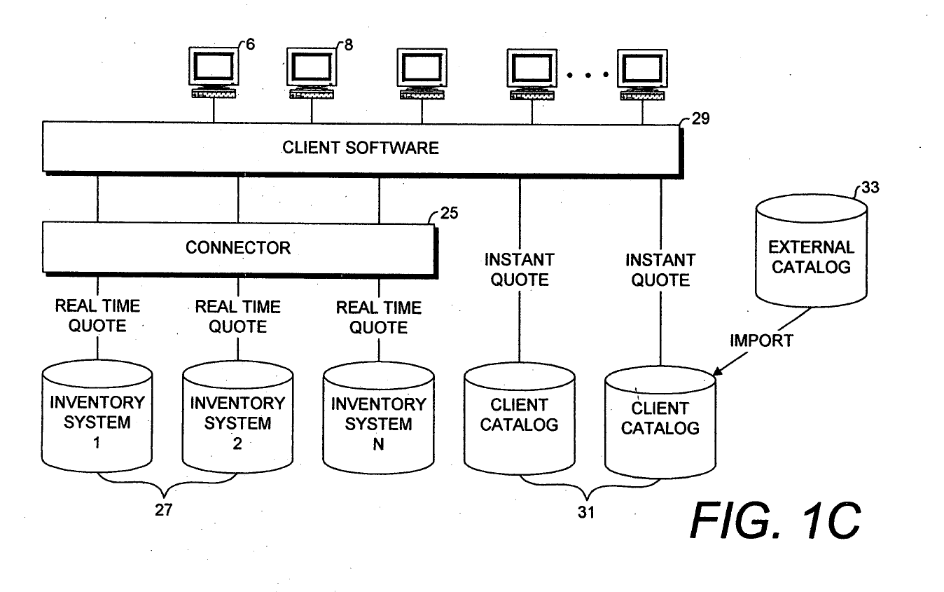

Referring to FIG. 1 in more detail, the reference numeral 2 generally designates a network transaction system embodying the present invention and including a home 4, a buyer 6 and a seller 8. Without limitation on the generality of useful applications of the present invention, the system 2 is generally described in connection with the home server 4 facilitating a commercial purchase transaction involving the buyer or customer 6 and the seller or vendor 8.

The home 4 can include one or more instant exchange (IX) home server(s) 10 comprising suitable computers, which can access a main database 12 including profile, user and filter information. The home server(s) 10 can also access a temporary database 14, which can include query, quote, login, sales and match information. Although the Internet (worldwide web) 13 is shown connecting the primary parties to the system 2, it will be appreciated that various other networks, including local-area networks (LANs), wide-area networks (WANs), or any other system or components can be utilized for interactively connecting the primary parties. The IX server(s) 10 can also connect to external links 15, which can include various resources such as other transaction systems, search engines, links via the Internet, other peer-to-peer resources, additional buyers, additional sellers, information sources, industry-specific resources, etc.

Client or user software 16, 20 is maintained at the IX home 4, or at a server(s) associated therewith, and typically resides on the IX. server(s) 10. The client software is downloadable, for example as buyer and seller user software 16 and 20, by users of the system 2. The client software 16, 20 includes programs of instructions, executable by computer, machine or the like, for providing the client or user with the ability to access the IX. server(s), and to facilitate any of the exemplary communications and transactions described below, in modes that utilize aspects of peer-to-peer communications. The client software 16, 20 allows users who have downloaded the client software to communicate among themselves. The client software, as described below, also allows users to enter various criteria into the system 2, and ultimately to the home 4 and the IX. server(s) 10, to selectively send and receive communications to and from one or more targeted users, which are targeted in accordance with criteria entered by users, who have also downloaded the client software.

The buyer 6 is associated with a first data object with the client software 16 and a buyer local database 18, which can include profile, quote, query and order information, functions and capabilities. The seller 8 is associated with a second data object with the client software 20 and a seller local database 22, which can include profile, catalog, specialty, quote, query, sales, messages and binary data (BD) connector information, functions and capabilities.

FIG. 1A shows a peer-to-peer private marketplace 23, which enables users, such as buyers 6 and sellers 8, to exchange queries and replies, which can be automated in the form of automated quotes or manual in the form of manual quotes. FIG. 1B shows the connections among the public marketplace 17, private marketplaces 19 and a private hotline 21. The system 2 can interact with the public marketplace, e.g. through the Internet, as directed by its users, who can control the interface with their private marketplaces 19 through rules and filters applied through the system 2. The users can also employee private hotlines 21 for enabling such functions as instant messaging or other inter-member communications.

FIG. 1C shows the operation of the client or user software 29 in connection with handling a query, e.g. seeking to purchase a product. Quotes can be obtained in real-time from users' inventory systems 27 through a connector 25. Instant quotes can be obtained from users' catalogs 31. The system 2 can interface with third-party inventory systems, as shown by the import connection with an external catalog 33. It will be appreciated that instant communication tools, such as instant messaging, facilitate interaction among system users in real-time. For example, queries can be instantly broadcast to a private marketplace, or a segment thereof, and automatically or manually replied to. Third-party interfaces can be provided as needed.

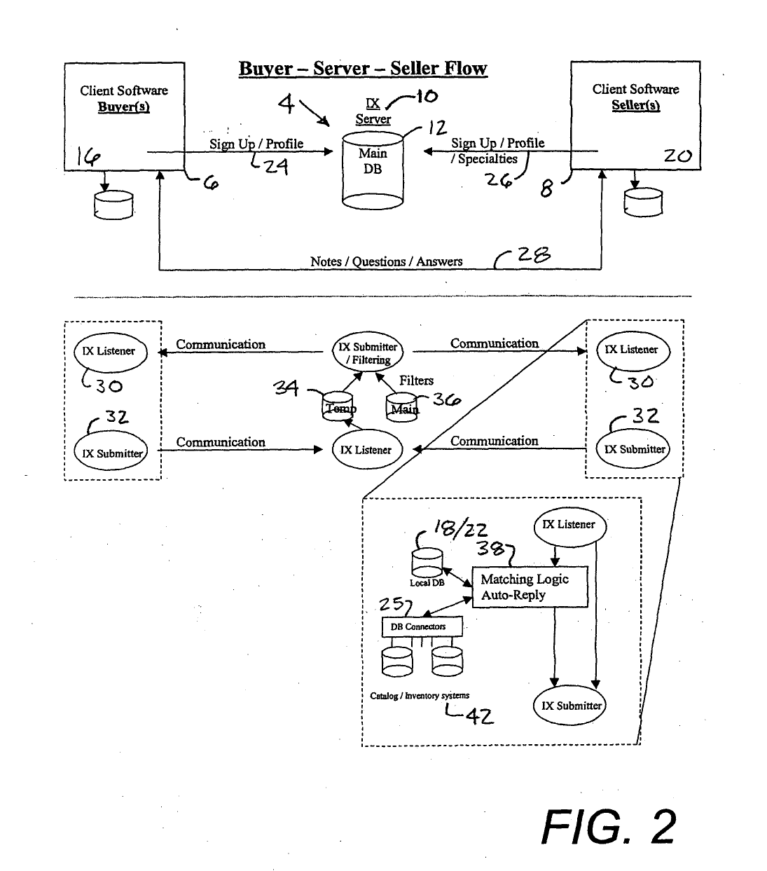

FIG. 2 shows the information flow among the IX. server 10, a buyer 6 and a seller 8. The buyers 6 and sellers 8 can input their respective sign up and profile information at 24, 26. The sellers 8 can also provide information about their specialties at 26. Notes, questions and answers can be exchanged at 28. IX listeners and submitters 30, 32 communicate through appropriate temporary and main filters 34, 36. Matching logic auto-reply is shown at 38 and connects to the local databases 18, 22 and to database connectors 25 (FIG. 1C) in conjunction with the catalog/inventory systems 42.

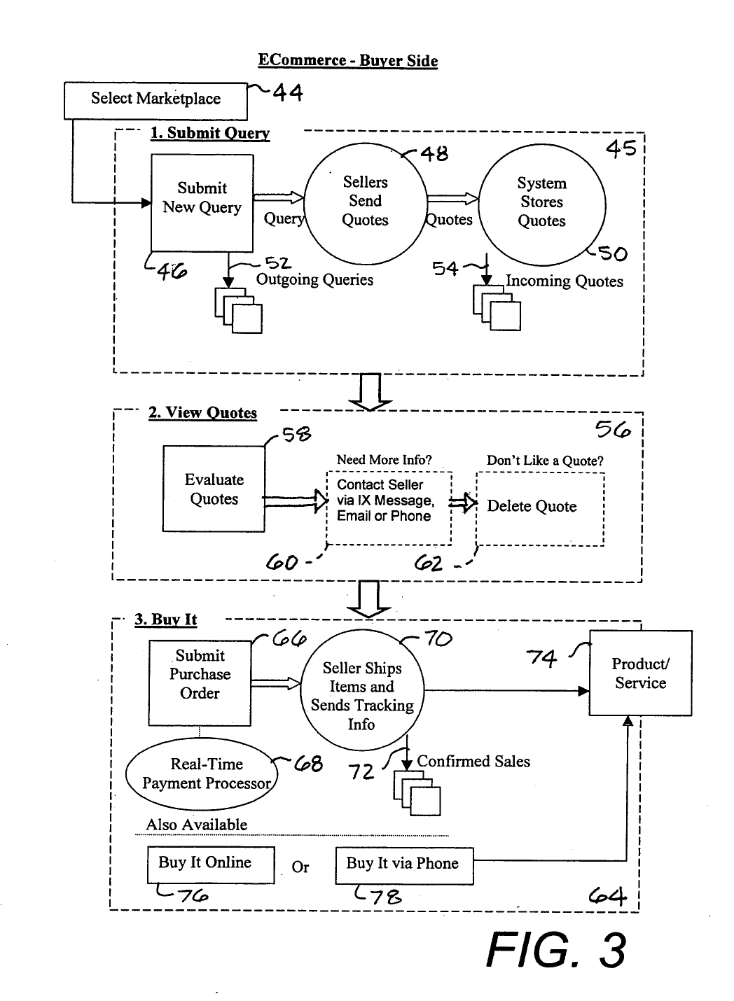

FIG. 3 shows the e-commerce methodology from the buyers' side. A marketplace is selected at 44 for input to a submitted query procedure 45, new queries are submitted at 46, sellers send quotes at 48 and the system stores the quotes at 50. Outgoing and incoming queries and quotes are transmitted at 52, 54. The quotes are viewed at procedure 56 for evaluation at 58, contacting the seller for more information at 60 and deleting unwanted quotes at 62. The purchase procedure is shown at 64, wherein a purchase order can be submitted at 66, and communicated to any real-time payment processor 68. A shipping and tracking information step occurs at 70 and links to confirm sales at 72. The goods or services involved in a transaction are represented at 74 for purchase online or via telecommunications at 76, 78.

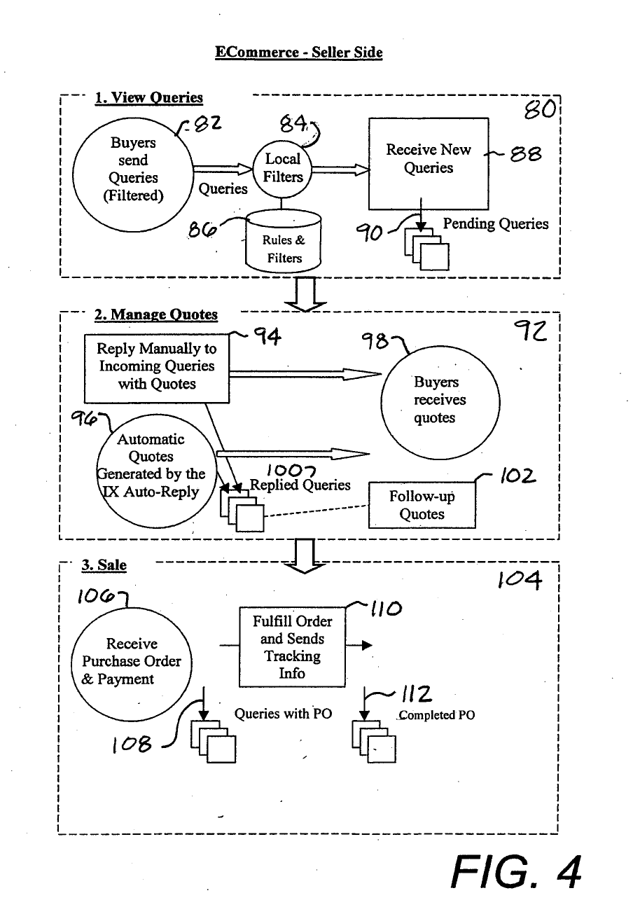

FIG. 4 shows the e-commerce from the sellers' side, including a procedure for viewing queries 80 including the steps of buyers sending filtered queries at 82, local filters and (business) rules and filters being applied at 84 and new queries being received at 88 for storing in pending queries at 90. The next procedure on the sellers' side involves managing quotes at 92 with a manual reply step at 94, automatic quotations generated by IX. auto-reply at 96, buyers receiving quotes at 98, and replied queries 100 generating follow-up quotes at 102.

It will be appreciated that the system 2 enables sellers 8 to automatically provide quotes in reply to queries, and to follow-up on same without the need for manual operator intervention. The next procedure on the sellers' side is a sale at 104 including receiving a purchase order and payment at 106, which can include a query at 108, fulfilling the order and sending tracking information at 110 and updating the completed purchase order to database at 112.

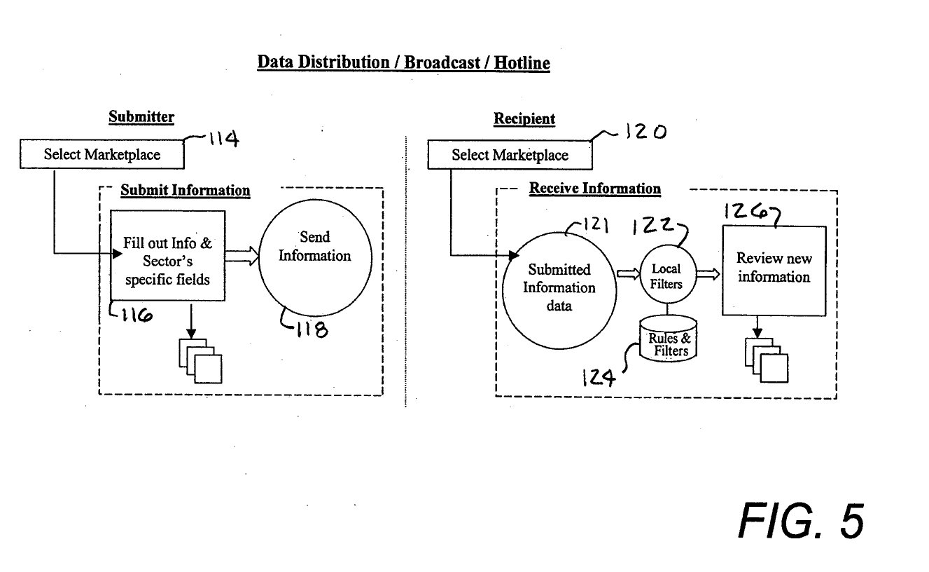

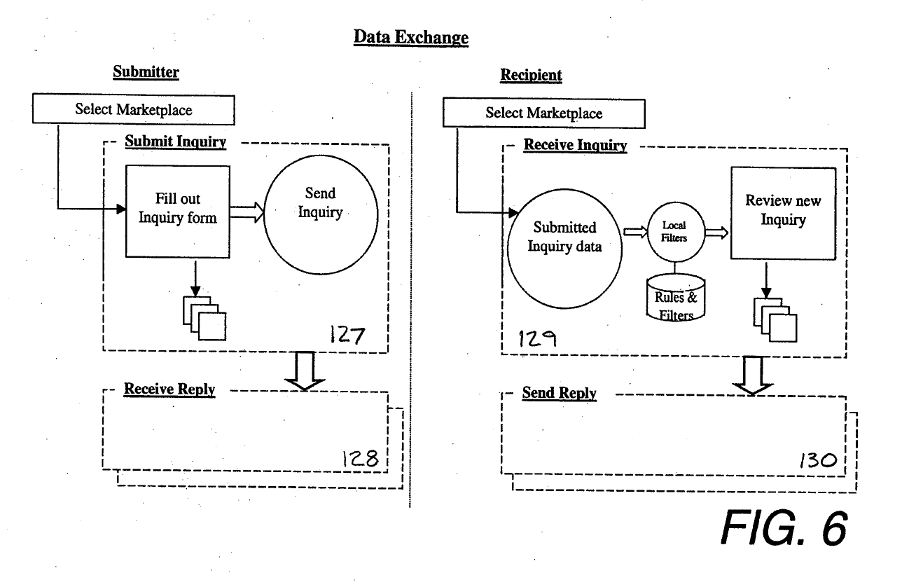

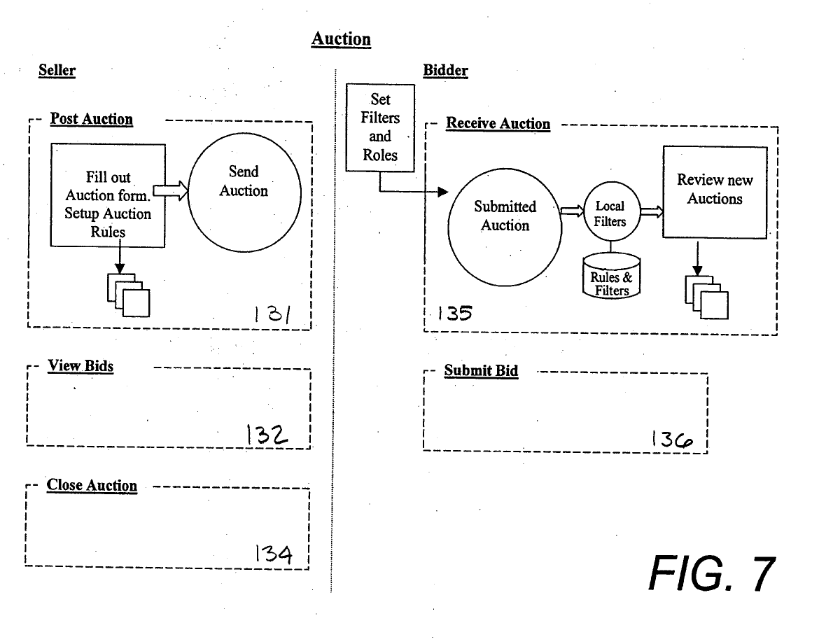

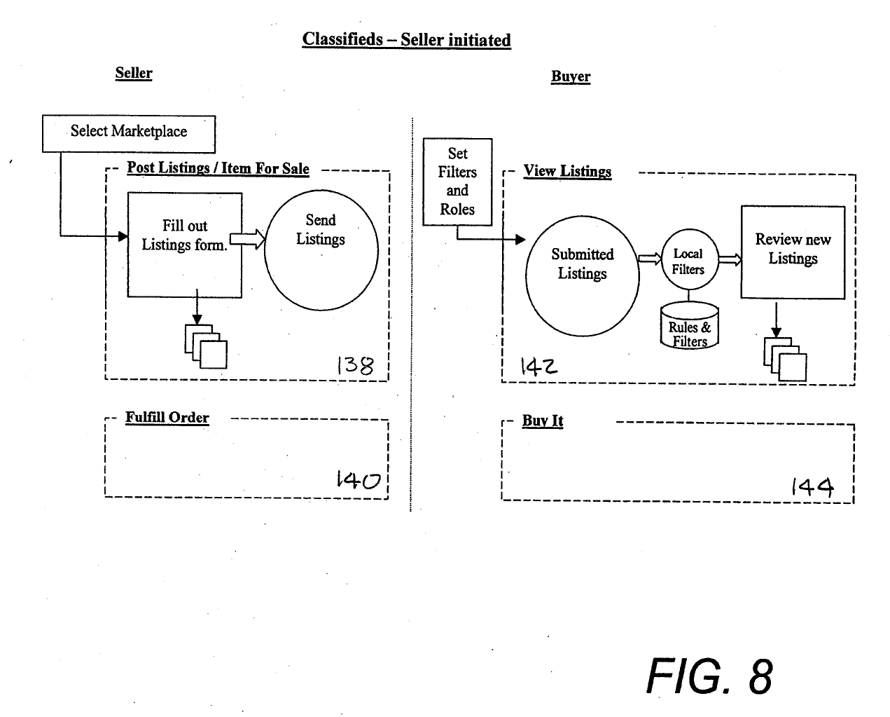

FIG. 5 shows the data distribution/broadcast/hotline procedure whereby a submitter selects a marketplace at 114, fills out information and (market) sector's specific fields 116 and information is sent at 118. On the recipient side the marketplace is selected at 120, submitted information data is provided at 121, local filters, (business) rules and filters are applied at 122, 124 and new information is reviewed at 126. FIG. 6 shows a data exchange procedure whereby inquiries are submitted at 127, replies are received by the submitter at 128, inquiries are received at 129 and replies are sent at 130. The functions involved within the inquiry procedures 128, 129, such as selecting marketplaces, filling out forms, sending forms, filters and storing information can be similar to the procedures within the data distribution/broadcast/hot line procedures shown in FIG. 5. Another variation using similar procedures or subroutines is shown in FIG. 7 in an auction application with the seller side including the steps of posting an auction 131, viewing bids 132 and closing the auction 134. On the bidders side, the auction can be received at 135 and bids can be submitted from the bidder (buyer) at 136. Yet another application of the system 2 in a classified advertising application is shown in FIG. 8 and includes procedures for posting listings of items for sale and fulfilling orders at 138, 140 on the sellers' side. On the buyer's side listings are viewed at 142 and items are bought at 144.

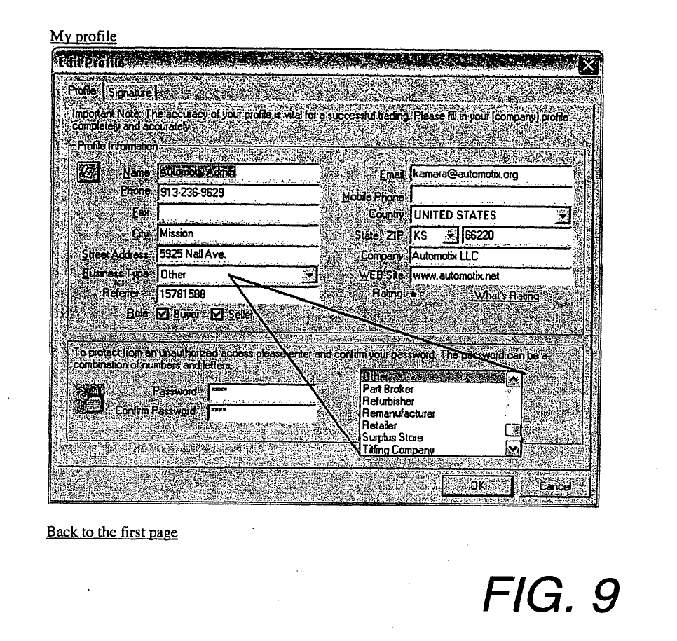

Screen Displays (FIGS. 9-26)

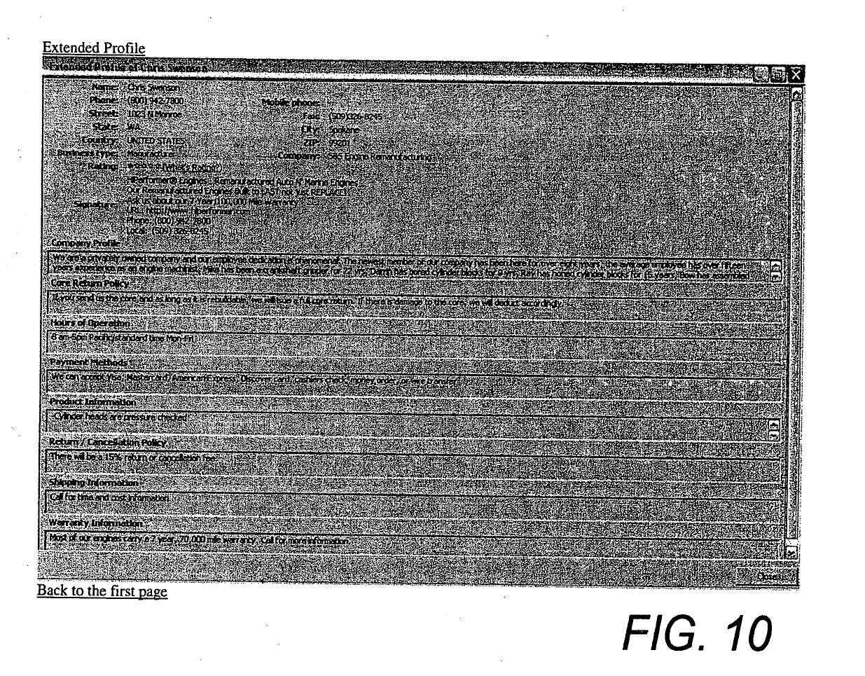

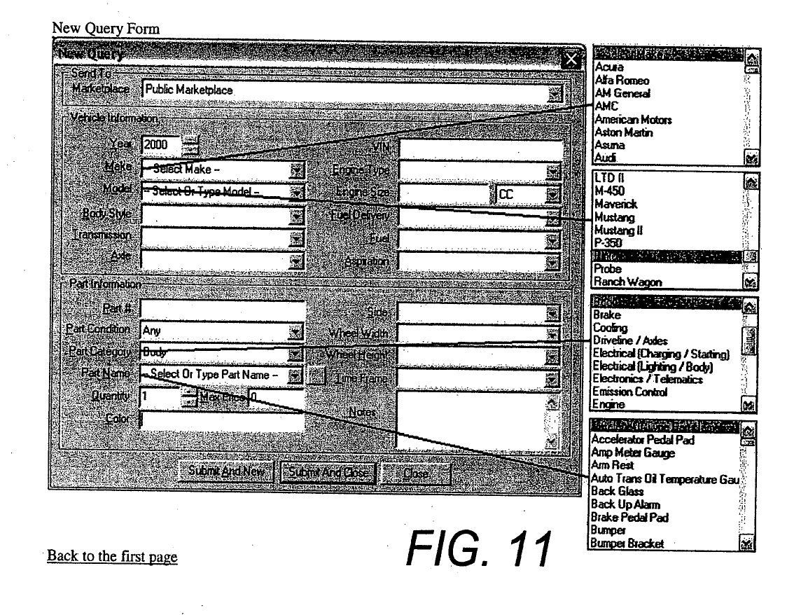

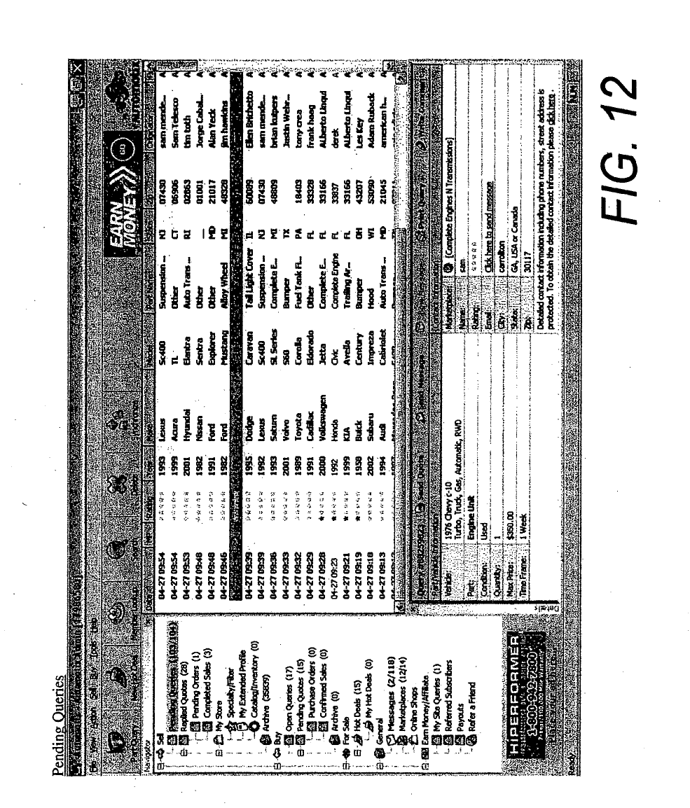

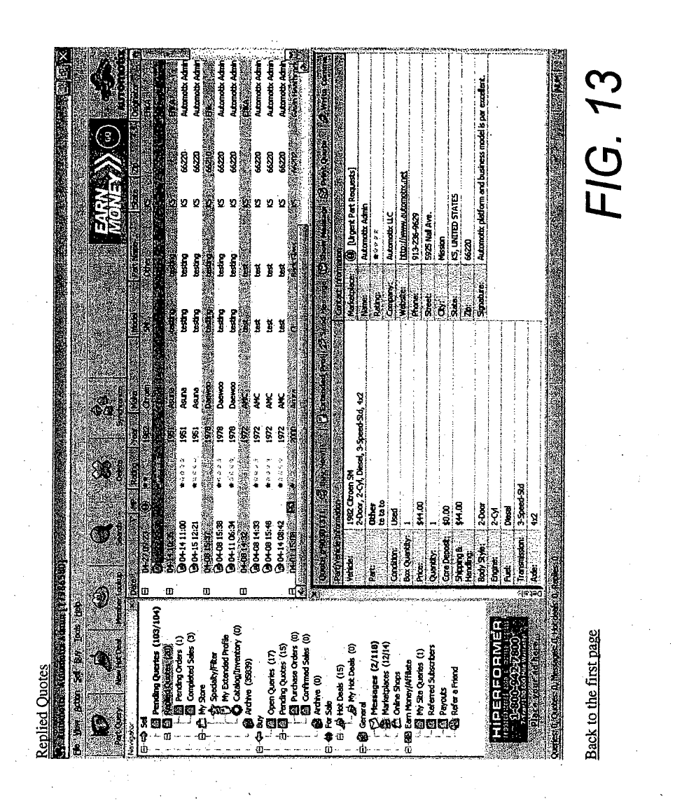

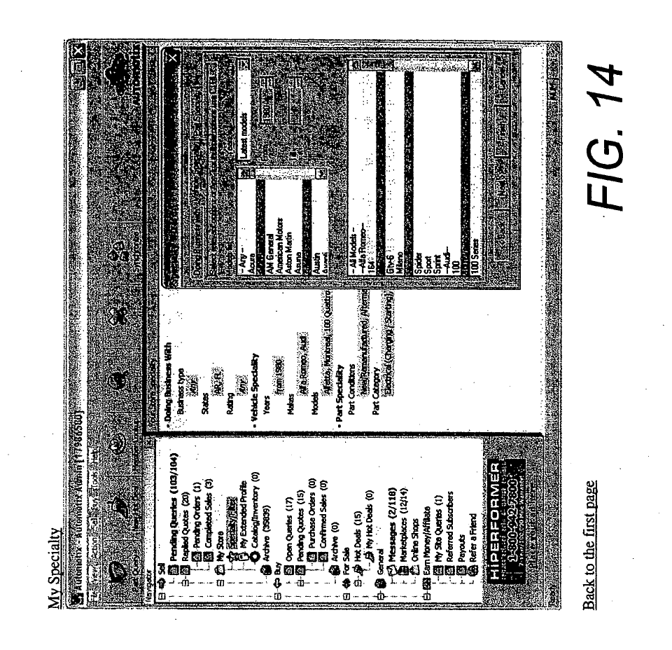

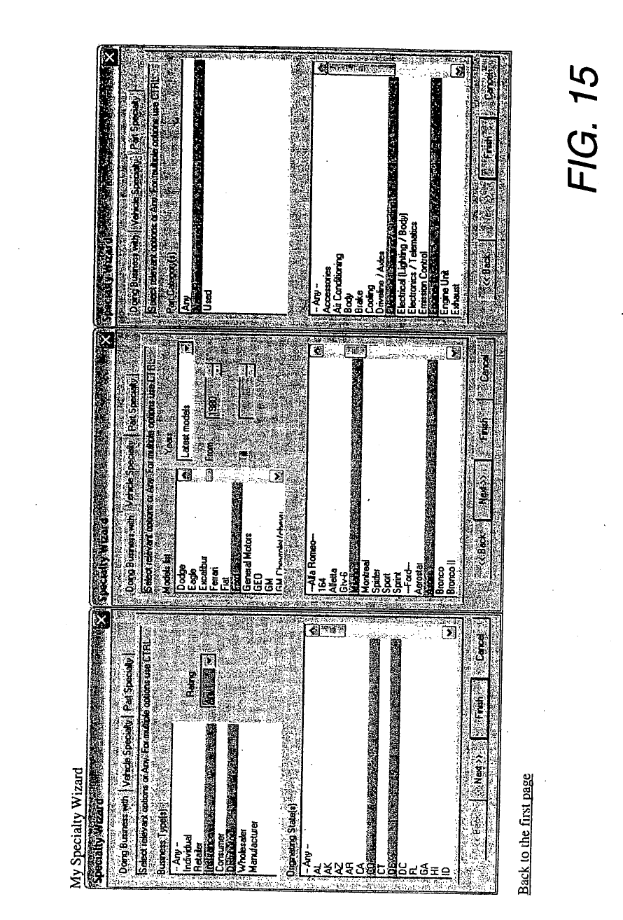

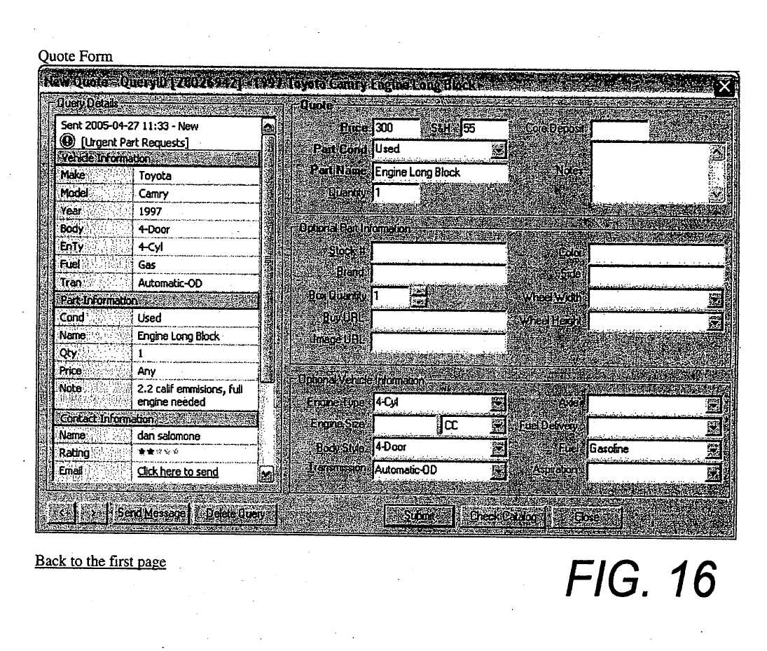

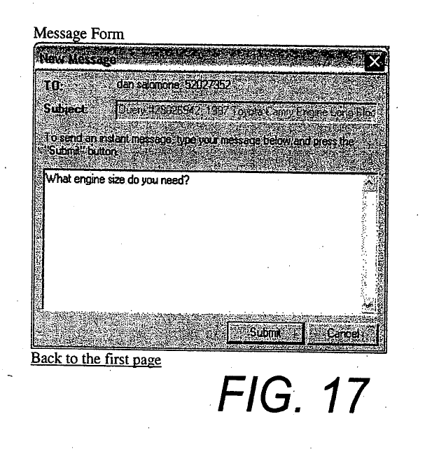

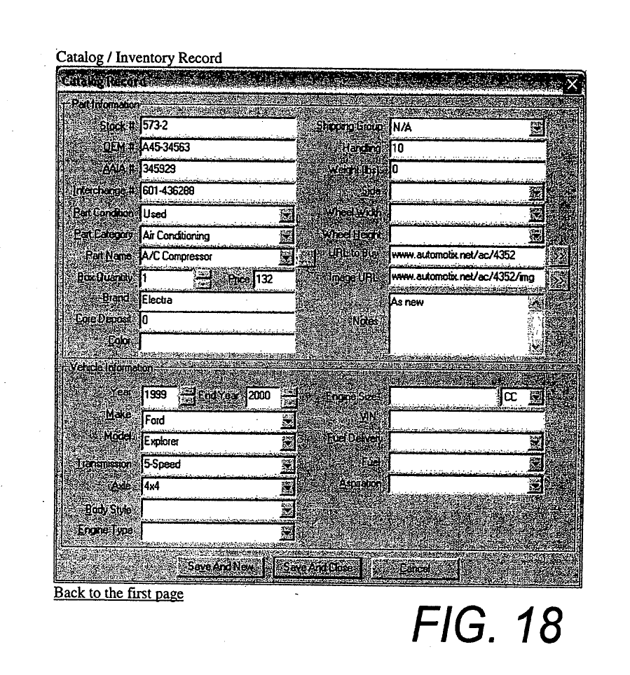

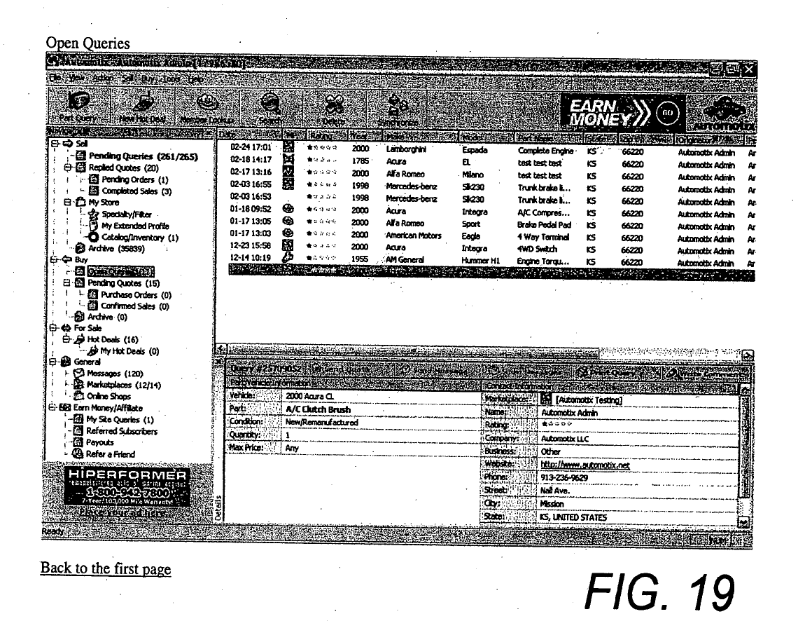

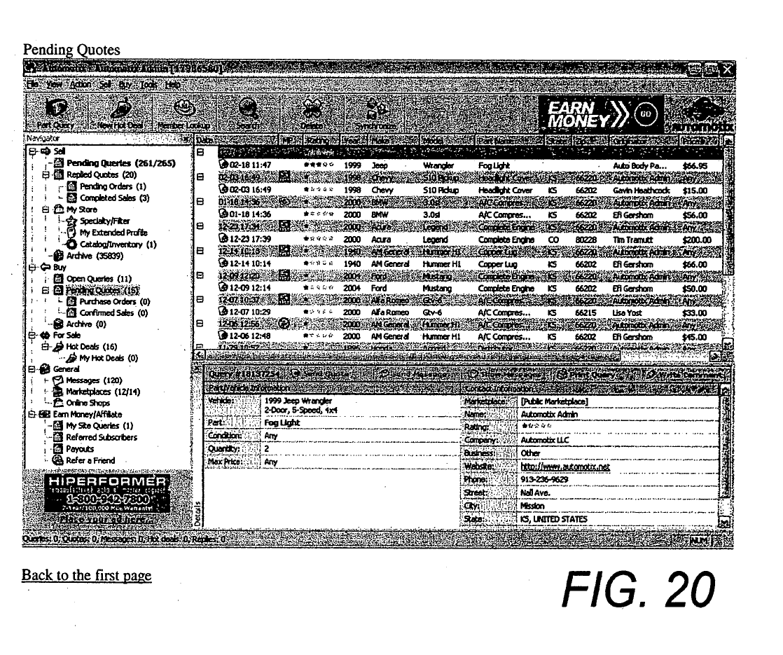

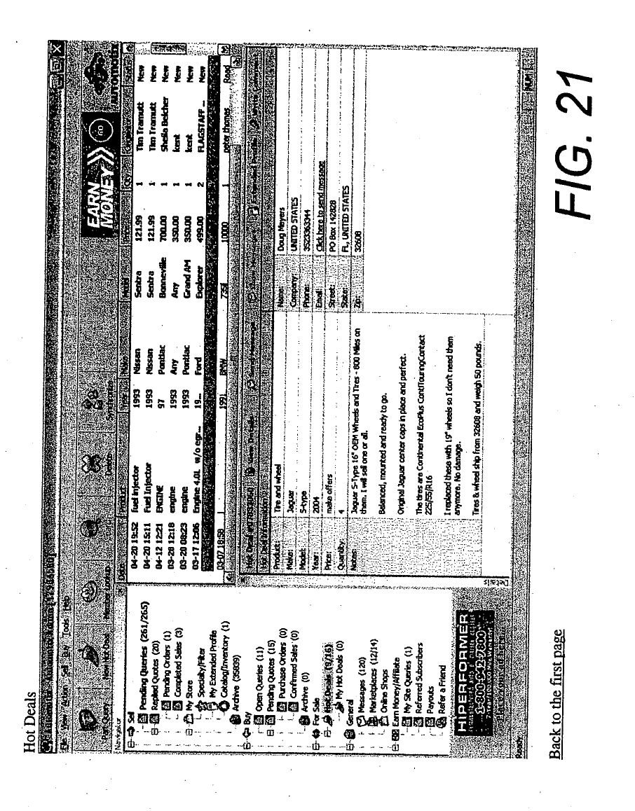

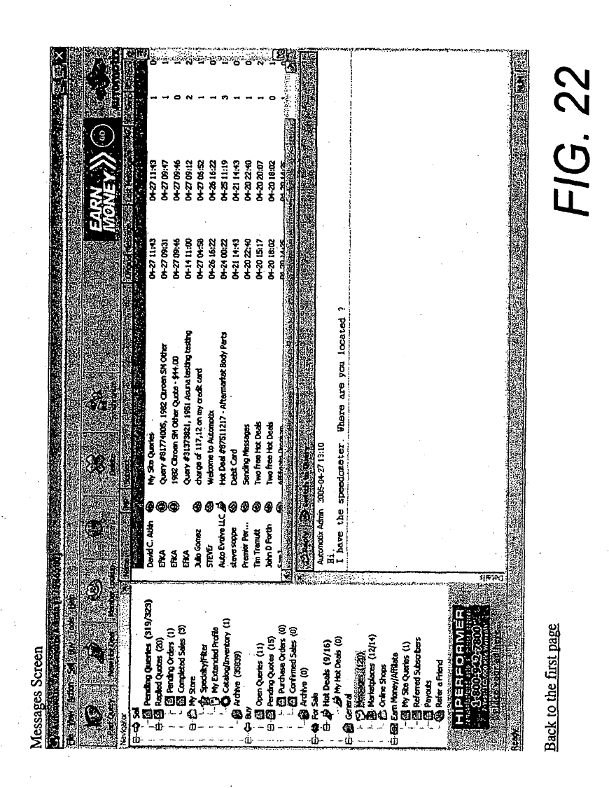

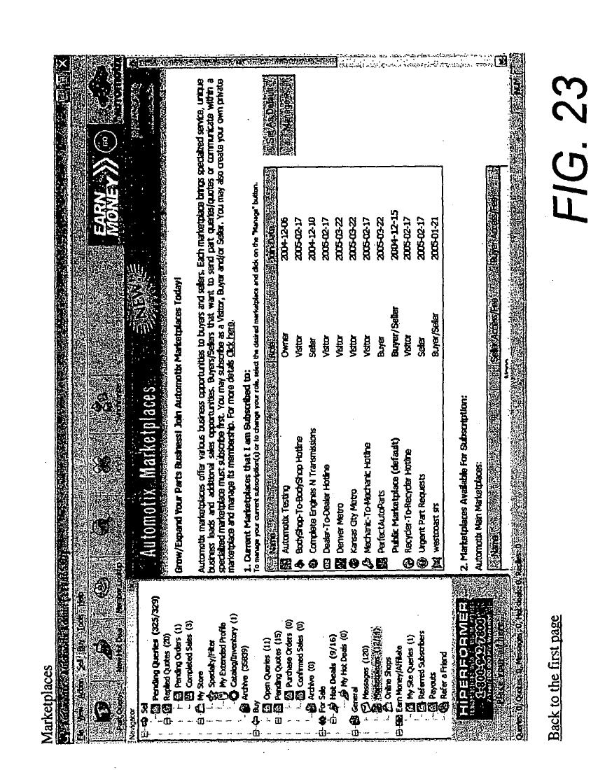

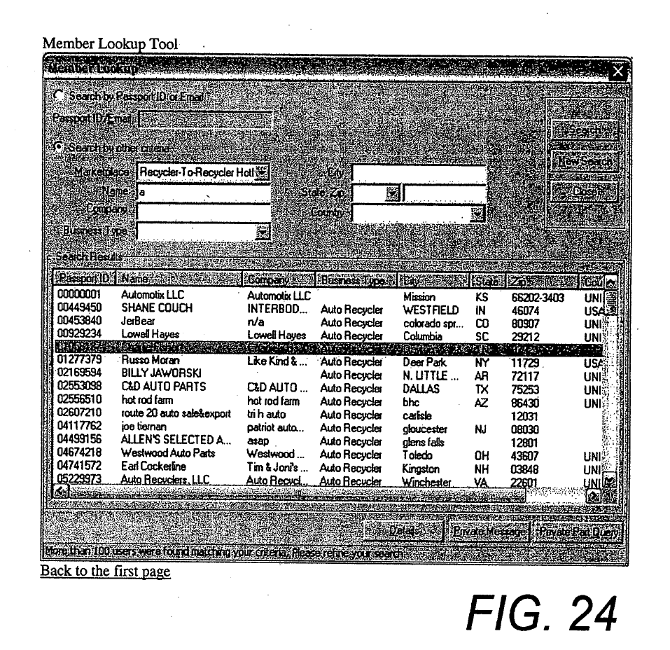

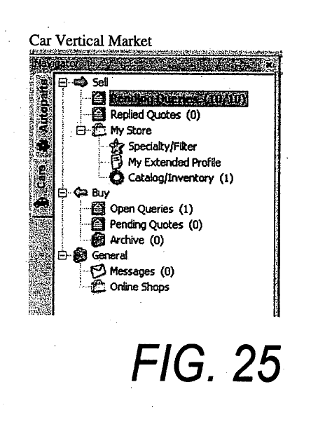

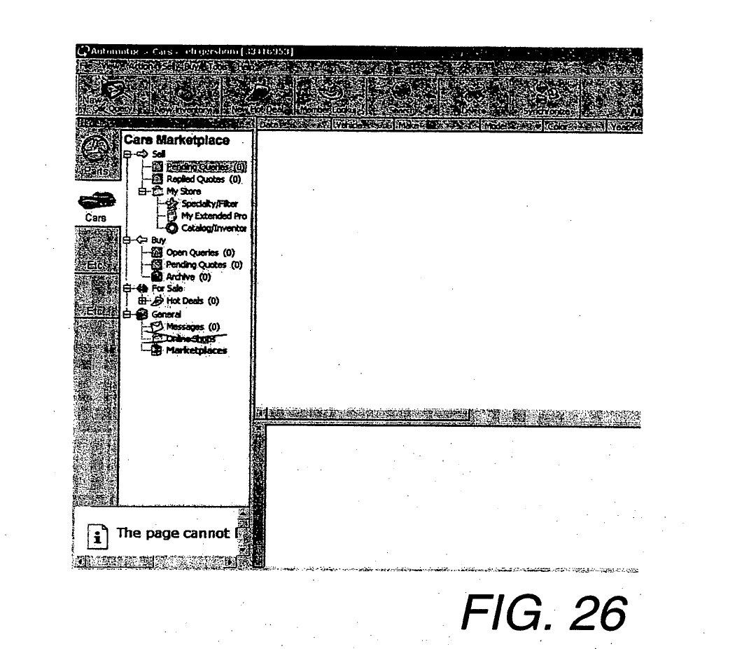

FIGS. 9-26 show screen displays from an application of the system and method of the present invention on a suitable computerized network, such as the Internet. FIG. 9 is a profile screen for user-specified information, which can be shown to other buyers 6 and sellers 8. The filtering criteria can also be determined from the information input to the screen, such as geographic location and business type and rule. FIG. 10 is an extended profile screen for users (sellers 8) to provide additional profile information, such as company information, shipping authority policies, and other terms and conditions. Such extended profile information can be transmitted to buyers 6 with every quote received by them. FIG. 11 shows a new query form for buyer use in submitting queries, e.g. for ordering specific goods or services. The information on this form can be distributed to all sellers with the corresponding filter settings and subscriptions. FIG. 12 is the sellers' main screen for pending queries, which can all be displayed for management by the sellers, e.g. by sorting the leads by category. FIG. 13 receives the information about sellers' replies to queries, including quotes. Future follow-ups can be initiated using the information captured by this screen. FIG. 14 enables sellers to manage their “store” specialties utilizing query filters whereby rules and parameters can be established for routing desired queries to sellers' computers. Irrelevant and unwanted queries can thus be avoided. FIG. 15 shows a specialty wizard for setting the sellers' specialty filters. FIG. 16 is a quote form for displaying buyers' query information, and allowing sellers to send quote information, e.g. prices, shipping arrangements, goods and services information, etc. to buyers. FIG. 17 is an instant message form whereby system users can communicate in many different transaction-based situations. FIG. 18 provides a catalog/inventory record for storing the inventory of users. An auto-reply option is provided for matching sellers' inventories to buyers' queries. FIG. 19 is a buyers' main screen for opening queries, which is adapted for displaying all queries sent by buyers that have not yet been quoted on by sellers. FIG. 20 shows replied queries with quotes, i.e. pending quotes, on the buyers' side, including a folder for displaying the buyers' initial queries with corresponding sellers' quotes. FIG. 21 is a “hot deals” section whereby users can post items that they wish to sell for unlimited times, similar to classified advertising. FIG. 22 is a messages screen display, which provides access to a folder for storing message-based communications among system users. FIG. 23 is a marketplaces display whereby users can communicate exclusively with their fellow subscribed buyers and sellers. System users can thereby use marketplaces as specific business platforms for purposes of focusing buying and selling efforts by specifying the marketplaces, which can enable communications among user groups. FIG. 24 shows a member lookup tool display whereby users can gain business information on fellow users, e.g. by looking up members in particular marketplaces. The screen display of FIG. 25 shows how an additional vertical market, e.g. automobiles, can be added. FIG. 26 shows a vertical marketplace for cars.

Potential Applications of the Network Transaction System and Method

Without limitation on the generality of useful applications of the network transaction system and method of the present invention, exemplary applications include the following:

Peer-To-Peer Commerce Solution (search, view, place an order, track it, etc.)

Peer-To-Peer Exchange Solution (transactions could be initiated either by the Buyer or Seller)

Peer-To-Peer Buy/Sell Solution

Peer-To-Peer Classifieds Solution

Peer-To-Peer Buyer-Seller Electronic Mail/Message Solution

Real Time Electronic Catalog Search (Peer-To-Peer)

Real Time Electronic Catalog Sharing/Linking (Peer-To-Peer)

Real Time Bidding System (Peer-To-Peer)

Peer-To-Peer Auction System (including Reverse Auctions)

Peer-To-Peer Broadcast/Hotline System

Peer-To-Peer data distribution Solution based on Rules, criteria, catalog and behavior of the users

Peer-To-Peer Member Lookup Solution

Peer-To-Peer Electronic Catalog Matching System

Peer-To-Peer Search Engine Alternative/Solution

Peer-To-Peer Commerce Solution

Encrypted data communication between two peers ensuring secure electronic commerce transactions

Peer-To-Peer Private Marketplace Solution

The above-described methods, including portions thereof, can be performed by software, hardware and combinations thereof. These methods and portions thereof can be performed by computers, computer-type devices, workstations, processors, microprocessors, other electronic searching tools and memory and other storage-type devices associated therewith. The processes and portions thereof can also be embodied in programmable storage devices, for example, compact discs (CDs) or other discs including magnetic, optical, etc., readable by machine or the like, or other computer-usable storage media, including magnetic, optical or semiconductor storage, or other storage of electronic signals.

The methods (processes) and systems, including components thereof, have been described herein with exemplary reference to specific hardware and software. The methods have been described as exemplary, whereby specific steps and their order can be omitted and/or changed by persons of ordinary skill in the hard to reduce these embodiments to practice without undue experimentation. The methods and systems have been described in a manner sufficient to enable persons of ordinary skill in the hard to readily adapt to other hardware and software as may be needed to reduce any of the embodiments to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

It is to be understood that while certain embodiments and/or aspects of the invention have been shown and described, the invention is not limited thereto and encompasses various other embodiments/aspects.

1. A network transaction system, which includes:
a network;
a home server connected to the network;
a user connected to the network and configured for accessing or being accessed by the home server, said user being associated with a party to a prospective transaction and adapted for transmitting a query to the home server or receiving a reply therefrom; and
said user including a criterion relating to said query or reply.

2. The system according to claim 1, which includes:
said user comprising a first user; and
a second user connected to the network and configured for accessing or being accessed by the home server, said second user being associated with another party to a prospective transaction and adapted for transmitting a query to the home server or receiving a reply therefrom; and
said second user including a criterion relating to said query or reply.

3. The system according to claim 2 wherein said first user is a prospective buyer of goods or services and said second user is a prospective seller of goods or services.

4. The system according to claim 1 wherein said criterion includes one or more criteria from the group comprising: rule; filter; user profile; catalog; and business specialty.

5. The system according to claim 2 wherein said first and second users include first and second computers respectively, said computers being programmed with peer-to-peer compatible user software for accessing or being accessed by said home server and said criteria are applied with filters or rules associated with said computers.

6. The system according to claim 5, which includes:
first and second local databases associated with said first and second computers respectively;
said first database being adapted for storing a profile, quotes, queries and orders; and
said second database being adapted for storing a profile, quotes, queries and sales.

7. The system according to claim 5 wherein said home server comprises an instant exchange (IX) computer and said first and second computers are preprogrammed with buyer and seller client software respectively for IX communication with said home server.

8. The system according to claim 2 wherein said second user includes:
a matching logic function adapted for matching a reply with a query; and
an auto-reply function adapted for automatically transmitting a predetermined reply in reply to a predetermined query.

9. The system according to claim 1 wherein said network is at least one of the group comprising: Internet worldwide web; a local-area network (LAN); and a wide area network (WAN).

10. The system according to claim 2 wherein said system is adapted for one or more applications from the group comprising: peer-to-peer commerce; peer-to-peer exchange; peer-to-peer buy/sell; peer-to-peer classifieds; peer-to-peer buyer-seller electronic mail/message; real time electronic catalog search (peer-to-peer); real-time electronic catalog sharing/linking (peer-to-peer); real time bidding (peer-to-peer); peer-to-peer auction system; peer-to-peer reverse auctions system; peer-to-peer broadcast/hotline system; peer-to-peer data distribution; peer-to-peer member lookup; peer-to-peer electronic catalog matching; peer-to-peer search engine alternative/solution; peer-to-peer commerce solution; encrypted peer-to-peer data communication; and peer-to-peer private marketplace.

11. The system according to claim 2, which includes:
said system providing a private marketplace accessible by said users;
a public marketplace selectively accessible through said private marketplace; and
interaction by said users with said public and private marketplaces being controlled by rules or filters comprising said criteria.

12. The system according to claim 2, which includes:
a first level of filters or rules applied by said home server;
a user-directed second level of filters or rules defined and applied by said users; and
said user-directed second level of filters being adapted for controlling a level of participation by said user in a vertical private marketplace.

13. The system according to claim 5, which includes:
said users maintaining catalogs or inventories on their respective computers for peer-to-peer access; and
said home server providing said peer-to-peer access using home server criteria installed thereon without storing said user catalogs or inventories whereby said system has a decentralized database function configuration.

14. The system according to claim 2, which includes:
a filter for controlling Internet-to-user and user-to-Internet connections; and
a private hotline function available to said users.

15. The system according to claim 2, which includes:
a connector for obtaining real-time quotes from user inventory systems; and
an instant quote function whereby a user can obtain an instant message quote from another user's catalog; and
an external catalog import function for importing information from a third-party to a user's catalog.

16. The system according to claim 2, which includes:
a cross-referencing function applied to first user queries for cross-referencing second user database information provided in reply; and
predetermined criteria applied to said cross-referencing function.

17. The system according to claim 2 wherein said users comprise a private marketplace with a common characteristic, business type or interest.

18. A network transaction system, which includes:
a network;
a home server connected to the network;
first and second users connected to the network and configured for accessing and/or being accessed by the home server, each said user being associated with a party to a prospective transaction and adapted for transmitting a query to the home server and/or receiving a reply therefrom;
each said user including a criterion relating to said query and/or reply;
said criteria on including one or more criteria from the group comprising: rule; filter; user profile; catalog; and business specialty;
said first and second users including first and second computers respectively, said computers being programmed with peer-to-peer compatible user software for accessing or being accessed by said home server and said criteria are applied with filters or rules associated with said computers;
first and second local databases associated with said first and second computers respectively;
said first database being adapted for storing a profile, quotes, queries and orders;
said second database being adapted for storing a profile, quotes, queries and sales;
said home server comprising an instant exchange (IX) computer and said first and second computers being preprogrammed with buyer and seller client software respectively for IX communication with said home server;
a matching logic function adapted for matching a reply with a query;
an auto-reply function adapted for automatically transmitting a predetermined reply in reply to a predetermined query;
said system providing a private marketplace accessible by said users;
a public marketplace selectively accessible through said private marketplace;
interaction by said users with said public and private marketplaces being controlled by rules or filters comprising said criteria;
a first level of filters or rules applied by said home server;
a user-directed second level of filters or rules defined and applied by said users;
said user-directed second level of filters being adapted for controlling a level of participation by said user in a vertical private marketplace;
said users maintaining catalogs or inventories on their respective computers for peer-to-peer access;
said home server providing said peer-to-peer access using home server criteria installed thereon without storing said user catalogs or inventories whereby said system has a decentralized database function configuration;
a connector for obtaining real-time quotes from user inventory systems;
an instant quote function whereby a user can obtain an instant message quote from another user's catalog; and
an external catalog import function for importing information from a third-party to a user's catalog.

19. A network transaction method, which comprises the steps of:
providing a home server;
connecting said home server to a network;
connecting a user to the network;
configuring the user for accessing or being accessed by the home server;
associating said user with a party to a prospective transaction;
transmitting a query to the home server or receiving a reply therefrom; and
providing said user with a criterion and applying same to said query or reply.

20. The method according to claim 19, which includes the additional steps of:
designating said user a first user;
providing a second user connected to the network and configured for accessing or being accessed by the home server, said second user being associated with another party to a prospective transaction and adapted for transmitting a query to the home server or receiving a reply therefrom; and
providing said second user with a criterion relating to said query or reply.

21. The method according to claim 20, which includes the additional step of:
selecting said criteria from the group comprising: rule; filter; user profile; catalog; and business specialty.

22. The method according to claim 20, which includes the additional steps of:
providing said first and second users with first and second computers respectively;
programming said computers with peer-to-peer compatible user software for accessing or being accessed by said home server; and
applying said criteria with filters or rules associated with said computers.

23. The method according to claim 20, which includes the additional steps of:
providing first and second local databases associated with said first and second computers respectively;
storing a profile, quotes, queries and orders on said first database; and
storing a profile, quotes, queries and sales on said second database.

24. The method according to claim 20, which includes the additional steps of:
providing an instant exchange (IX) computer for said home server;
programming said first and second computers with buyer and seller client software respectively for IX communication with said home server; and
providing said second computer with a matching logic function adapted for matching a reply with a query and an auto-reply function adapted for automatically transmitting a predetermined reply in reply to a predetermined query.

25. The method according to claim 20, which includes the additional steps of:
providing a private marketplace accessible by said users;
selectively accessing a public marketplace through said private marketplace; and
controlling interaction by said users with said public and private marketplaces by rules or filters comprising said criteria.

26. The method according to claim 20, which includes the additional steps of:
applying a first level of filters or rules with said home server;
applying a user-directed second level of filters or rules defined and applied by said users; and
controlling a level of participation by said users in a vertical private marketplace with said user-directed second level of filters.

27. The method according to claim 20, which includes the additional steps of:
providing a connector for obtaining real-time quotes from user inventory systems; and
providing an instant quote function whereby a user can obtain an instant message quote from another user's catalog; and
importing an external catalog with information from a third-party to a user's catalog.
